(19) United States
(12) Patent Application Publication
(10) Pub. No.: US 2013/0268457 A1
(43) Pub. Date: Oct. 10, 2013

(54) System and Method for Extracting Aspect-Based Ratings from Product and Service Reviews

(71) Applicants: Jun Wang, San Jose, CA (US); Kanji Uchino, San Jose, CA (US)

(72) Inventors: Jun Wang, San Jose, CA (US); Kanji Uchino, San Jose, CA (US)

(73) Assignee: FUJITSU LIMITED, Kanagawa (JP)

(21) Appl. No.: 13/440,204

(22) Filed: Apr. 5, 2012

(51) Int. Cl. G06Q 30/02

(52) U.S. Cl. 705/347

(57) ABSTRACT

A system method that may include generating a text feature vector including a plurality of elements for an aggregate review text associated with one or more multi-aspect reviews of a product or service, each element of the text feature vector associated with a term in the aggregate review text, calculating an average aspect rating for each of a plurality of aspects having a rating in the one or more multi-aspect reviews of the product or service, generating a rating vector, the rating vector including a plurality of values and elements, each element of the rating vector corresponding to an average aspect rating, and generating an inference model based on the text feature vectors and a frequency of occurrence of each rating vector, such that the inference model may be applied to text reviews to infer aspect ratings associated with the text reviews.

### TECHNICAL FIELD

This disclosure generally relates to user or customer opinion analysis.

### BACKGROUND

Developers, manufacturers, retailers, and marketers often collect opinions or feedback concerning their products or services from their users or customers. These opinions or feedback may be collected from various sources, both online and offline. Sometimes, a user or customer may be asked to rate a product or service as a whole (e.g., using a predefined rating scale), or rate different attributes, features, or aspects of a product or service. Sometimes, a user or customer may be given the opportunity to comment on a product or service (e.g., as free-form text). The opinions or feedback collected from the users or customers may be analyzed for various purposes, such as improving design or functionalities of existing products or services, developing new products or services, product or service selection, and targeted marketing.

### SUMMARY

In accordance with the present disclosure, a system and method may include generating a text feature vector including a plurality of elements for an aggregate review text associated with one or more multi-aspect reviews of a product or service, each element of the text feature vector associated with a term in the aggregate review text, and a value of each element of the text feature vector corresponding to occurrence of term in the aggregate review text and all aggregate review text collection. The system and method may also include calculating an average aspect rating for each of a plurality of aspects having a rating in the one or more multi-aspect reviews of the product or service. The system and method may additionally include generating a rating vector, the rating vector including a plurality of values and elements, each element of the rating vector corresponding to an average aspect rating for each aspect having a rating in the one or more multi-aspect reviews of the product or service. The system and method may further include generating an inference model based on the text feature vectors and rating vectors, such that the inference model may be applied to text reviews to infer aspect ratings from the text reviews.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates a system of extracting aspect-based ratings from product and service reviews, in accordance with embodiments of the present disclosure;

FIG. 2 illustrates example reviews with aspect ratings, in accordance with embodiments of the present disclosure;

FIGS. 3A and 3B illustrate selected components of a pre-processing/feature selection module, in accordance with embodiments of the present disclosure;

FIG. 4 illustrates a flow chart of an example method of extracting aspect-based ratings from product and service reviews, in accordance with embodiments of the present disclosure;

FIG. 5 illustrates an example computer system, in accordance with embodiments of the present disclosure; and

FIG. 6 illustrates an example network environment, in accordance with embodiments of the present disclosure.

### DESCRIPTION OF EXAMPLE EMBODIMENTS

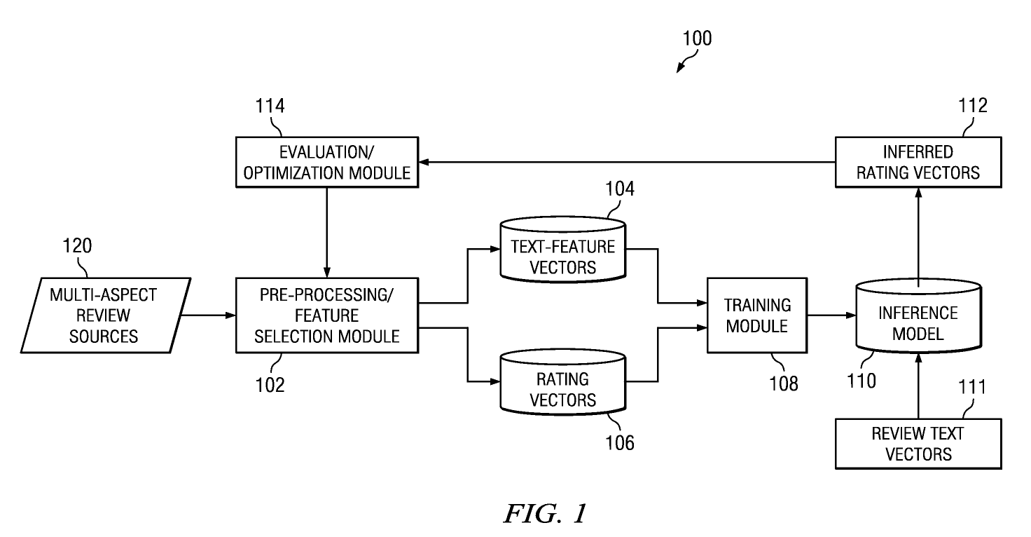

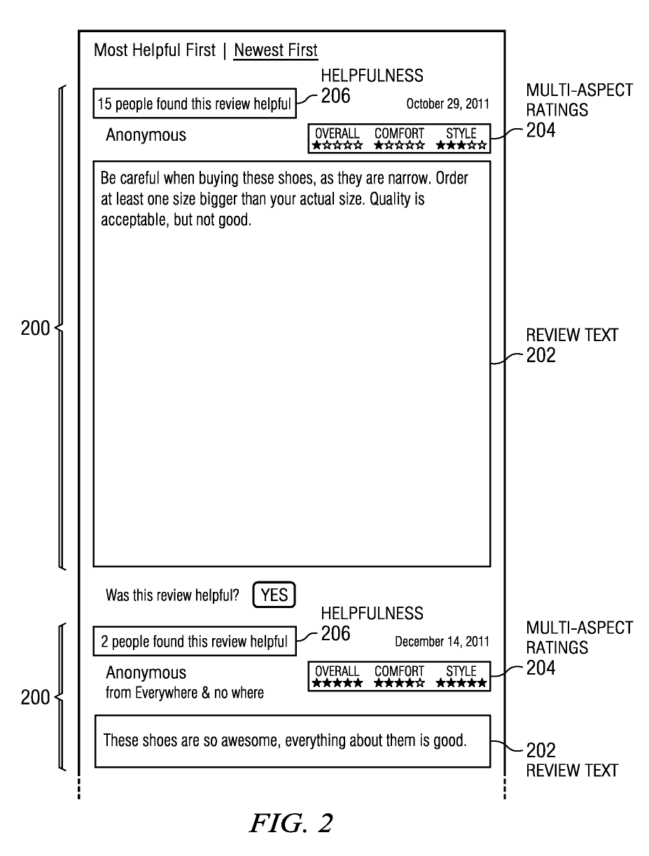

FIG. 1 illustrates a system 100 for extracting aspect-based ratings from product and service reviews, in accordance with embodiments of the present disclosure. In particular embodiments, reviews comprising user opinions or opinion expressions concerning products or services are collected from various sources 120, either offline or online or both. Reviews comprising user opinions may be collected from any number of sources 120 having both text reviews and associated multi-aspect ratings, and this disclosure contemplates any applicable opinion source 120. For example, reviews comprising user opinions or opinion expressions may be collected from product surveys, social-networking websites, or e-commerce websites. A product may be a physical product or a software product. In particular embodiments, review sources 120 may include multi-aspect ratings. As used herein, multi-aspect ratings are an expression of user sentiment for a product or service in which a user expresses a quantitative score or rating (e.g., 0 to 5 stars, 0 to 10 points, like or dislike, etc.) regarding multiple aspects of the product or service. Example reviews 200 with aspect ratings are described in greater detail with respect to FIG. 2 below.

In operation, system 100 may, as described in greater detail below receive reviews 200 from multi-aspect review sources 120 and, based on analysis of multi-aspect reviews 200, train and generate an inference model 110 that may be used to infer a correlation between review text feature vectors (e.g., generated from review texts 202 of multiple reviews 200) and multi-aspect rating vectors (e.g., generated from multi-aspect ratings 204 or multiple reviews 200). Inference model 110 may then be applied to generate rating vectors from review text feature vectors, without the need to input rating vectors, thus allowing quantitative multi-aspect ratings to be generated based solely on review texts. Accordingly, inference model 110 may be used to generate multi-aspect ratings from review sources which do not include user-provided multi-aspect ratings.

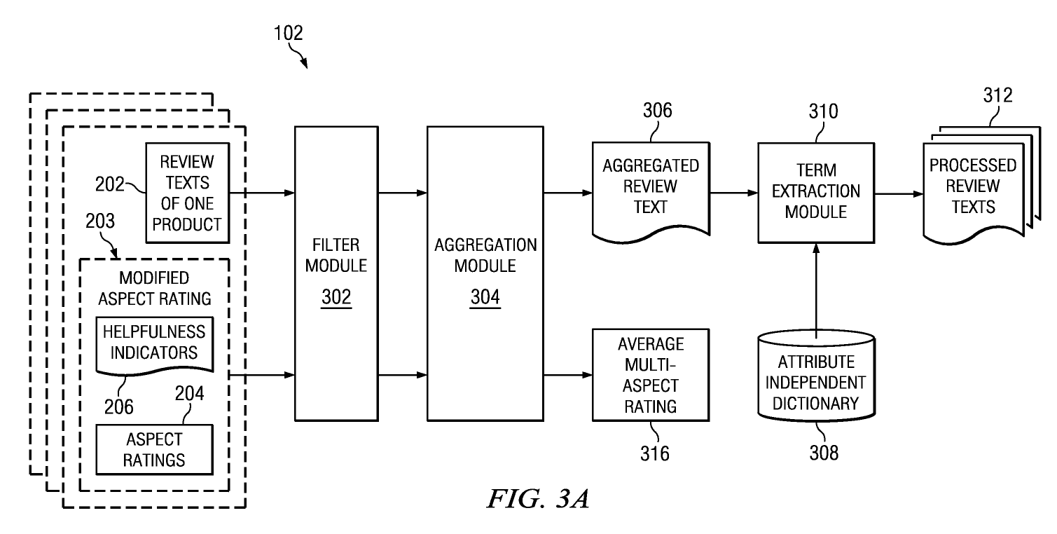

As shown in FIG. 1, system 100 may include a pre-processing/feature selection module 102. Pre-processing and feature selection module 102 may analyze multi-aspect review sources 120 to generate text-feature vectors 104 and rating vectors 106, as described in greater detail below with respect to FIGS. 3A and 3B. A training module 108 may receive text-feature vectors 104 and rating vectors 106 as inputs, and based on such inputs, generate inference model 110. Training module 108 may use text-feature vectors 104 and rating vectors 106 as training data to train a computer to learn to generate rating vectors based on review texts using machine learning. Machine learning is a scientific discipline that is concerned with the design and development of algorithms that allow computers to learn based on data. The desired goal is to improve the algorithms through experience (e.g., by applying the data to the algorithms in order to “train” the algorithms). The data are thus often referred to as “training data”. The machine learning process trains computers to learn to perform certain functionalities. Typically, an algorithm is designed and trained by applying training data to the algorithm. The algorithm is adjusted (i.e., improved) based on how it responds to the training data. Often, multiple sets of training data may be applied to the same algorithm so that the algorithm may be repeatedly improved. Types of training performed by support vector machine, support vector regression, canonical correlation analysis, naïve Bayes, regression tree, linear regression, and/or any other suitable type of machine learning.

To further optimize inference model 110, inference model 110 generated from text-feature vectors 104 and rating vectors 106 may be supplied with review text vectors 111 from review texts used to generate inference model 110 in order to generate inferred rating vectors 112. Such review text vectors may be generated in a manner similar to or identical to text-feature vectors 104. Evaluation/optimization module 114 may evaluate inferred rating vectors 112 (e.g., by comparison to actual ratings associated with the actual review texts 202) to determine deviation from actual ratings. For example, a deviation 4 may be calculated in accordance with the equation

Δ=Σᵢ₌₁ⁿD(C_{Ri}, C_{Ii})/n

where C_{Ri} represents a coordinate value of the ith actual aspect rating vector, C_{Ii} represents a coordinate value of the ith inferred aspect rating vector, n is the number of review samples, and D(C_{Ri}, C_{Ii}) is the distance between C_{Ri} and C_{Ii}.

Based on such determined deviation, one or more aspects of pre-processing and feature selection module 102 may be modified in order to optimize creation of inference model 110. For example, in response to a deviation, terms selected by text feature vector creation module 320 (see description of FIG. 3 below) may be modified. In addition or alternatively, various constants applied to or by various components of system 100 (e.g., constants α, λ, etc. described elsewhere in this disclosure), and/or various thresholds applied to or by various components of system 100 (e.g., as such thresholds may be described elsewhere in this disclosure) may be modified. The iterative process of generating an inference model 110 and evaluation and optimization of inference model 110 by evaluation/optimization module 114 may be performed any suitable number of times. For example, such iterative process may repeat until such time as the deviation between actual ratings used as input to system 100 and inferred ratings generated by inference model 110 are below a threshold deviation.

Once a generated inference model 110 is found to be within the threshold deviation, it may be used to generate inferred ratings based solely on review texts for products or services. For example, inference model 110 may be applied to a source of text-only reviews (e.g., without aspect ratings) to infer aspect ratings based solely an analysis of the text and application of inference model 110 to the analyzed text.

FIG. 2 depicts example reviews 200 with aspect ratings 204, in accordance with embodiments of the present disclosure. As shown in FIG. 2, a review 200 may include numerous fields. For example, a review 200 may include a review text 202, which may include a free-form narrative setting forth a user opinion for a particular product or service. A review 200 may also include a plurality of aspect ratings 204 in which a user expresses a score for each of a plurality of aspects. The aspects of “overall,” “comfort,” and “style” might be appropriate in a multi-aspect review 200 depicted in FIG. 2 for a shoe or article of clothing, for example. Different numbers of aspects and aspects themselves may vary based on the type of product or service reviewed. For example, multi-aspect ratings for a hotel may include aspects of “overall,” “value,” “location,” “sleep quality,” “rooms,” “cleanliness,” and “service.” As another example, multi-aspect ratings for a restaurant may include “overall,” “price,” “quality,” “service,” and “ambiance.” As shown in FIG. 2, a review 200 may also include a helpfulness indicator 206. A helpfulness indicator 206 may set forth a number of persons viewing a particular review 200 that have indicated (e.g., by “clicking” a user interface button) that they found the particular review helpful.

FIGS. 3A and 3B illustrate selected components of pre-processing and feature selection module 102, in accordance with embodiments of the present disclosure. As shown in FIG. 3A, pre-processing and feature selection module 102 may comprise a filter module 302 configured to filter review texts 202 and/or aspect ratings 204 of a particular product or service. For example, filter module 302 may remove reviews without text or with short text (e.g., review texts below a specified number of words) and associated aspect ratings 204 and/or helpfulness indicators 206 associated with such removed reviews. In addition or alternatively, filter module 302 may remove particular words from review texts 202, such as certain low-frequency words, articles (e.g., a, an, the), conjunctions (e.g., and, or), pronouns (e.g., it), and/or other words.

As depicted in FIG. 3A, pre-processing and feature selection module 102 may also include an aggregation module 304. Aggregation module 304 may aggregate filtered review texts for a particular product or service to produce aggregated review text 306 for the particular product or service. For example, aggregation module 304 may aggregate filtered review texts by aggregating all filtered reviews for a particular product or service in a single composite review. Often, review texts in multi-aspect ratings may not be voluminous enough to cover all aspects being rated. Thus, to avoid sparseness and the possibility of omitting aspect descriptions, all reviews for a particular product or service may be aggregated.

Similarly, aggregation module may average aspect ratings 204 for each of the aspects of the particular product or service to generate average aspect rating 316 for the product or service. Prior to averaging by aggregation module 304, the aspect ratings 204 associated with each particular individual review 200 may be modified by the helpfulness indicator 206 associated with the particular review 200. For example, a helpfulness factor H may be calculated that is a function of the number of users indicating a review is helpful p and the number of reviews N for the product or service. In some embodiments, the helpfulness factor may be given by the equation:

H=1+log((p+λ)/N)

where λ is a constant value. The value of λ may be a user-specified value and/or may be a value that may be adjusted by evaluation/optimization module 114, and may determine the extent at which aspect ratings 204 are modified by helpfulness indicators 206. Thus, as a particular example, an average rating vector R_{avg} may be given by the equation R_{avg}=Σ(H*R)/Σ(H), where R represents individual rating vectors of the individual reviews.

The average aspect rating 316 may be represented as a vector. In some embodiments, each element in such vector may be a whole number (e.g., an average rounded to the nearest whole number). For example, an averaged aspect rating 316 for a pair of shoes having aspect ratings for the categories of “overall,” “comfort,” and “style” may be represented by a three-element vector [a, b, c], where the values for a, b, and c correspond to “overall,” “comfort,” and “style,” respectively. In addition, aggregation module 304 may take into account helpfulness indicators 206 for reviews of the particular product or service in aggregating aspect ratings 204. As depicted in FIG. 3A, a term extraction module 310 may extract particular terms (e.g., words and/or phrases) from aggregated review text 306 based on terms present in an attribute-independent dictionary 308 and add these terms to aggregated review texts 306 to produce processed review texts 312. Attribute-independent dictionary 308 may comprise a predefined set of words or phrases, which may be applicable and used to describe features or attributes of products or services. For example, the predefined set or words and phrases may be words or phrases that users may use to express their views when providing opinions or feedback concerning various products or services. In some implementations, the dictionary 308 may include words (e.g., adjectives, adverbs, nouns, verbs, etc.) that describe or express users' opinions on products or services (e.g., “powerful”, “good”, “bad”, “terrible”, “efficiently”, “beauty”, “junk”, “hate”, “like”, etc.). As its name suggests, dictionary 308 may be an attribute-independent dictionary. As used herein, an attribute-independent dictionary is one including terms that may be generally applicable to all types of products and services, while an attribute-dependent dictionary is one including terms the would be applicable to a certain or product or service or to a particular type of service. For example, terms indicative of a pixel resolution, image format, aperture, shutter speed, and/or lens type might be specific to a digital camera, and thus would be considered attribute-dependent, while terms indicative of price, quality, aesthetics, etc. might be generally applicable to all types of products and services, and thus would be considered attribute-independent. An attribute-independent dictionary may be preferable over an attribute-dependent dictionary as such an attribute-independent dictionary may be easier to produce, whereas an attribute-dependent dictionary may require labor-intensive work.

In addition, term extraction module 310 may analyze aggregated review texts 306 to extract negation indicators (e.g., “not,” “never,” “n't,” etc.) and/or intensity indicators (e.g., “really,” “truly,” “very,” etc.) present in dictionary 308. To illustrate, certain words may be considered as negation indicators or intensity indicators (e.g., adverbs). For example, a sentence may state, “This car is not good.” Even though the word “good” is a positive adjective, the word “not” negates that positive adjective so that the user actually means to say that the car is bad, which is negative. In this case, the word “not” is considered a negation indicator because it negates some other words in the sentence. As another example, a sentence may state, “This car is very good.” In this case, the word “very” further intensifies the word “good”, indicating that the user considers the car extraordinarily good. Another sentence may state, “This car is absolutely terrible.” Here, the word “absolutely” further intensifies the word “terrible”. In these two cases, the words “very” and “absolutely” are considered intensity indicators because they further intensify some other words in the review texts.

The various modules depicted in FIG. 3A may be applied to each particular product and service of the same class (e.g., running shoes) available in multi-aspect review sources 120. A plurality of aggregated review texts 314 and a plurality of average aspect ratings 316 for multiple products and/or services may be further processed as shown in FIG. 3B. As shown in FIG. 3B, a rating vector distribution analysis module 318 may analyze a plurality of average aspect ratings 316 for various products (wherein each average aspect rating 316 may be represented as a vector as set forth above). In some instances, the number of possible vectors representing average aspect ratings 316 may be large. For example, in multi-aspect ratings having three aspects with five possible values each, 125 different vectors are possible. In addition, in some cases, analysis of the frequency of the various possible vectors in average aspect ratings 316 may indicate a distribution with a long tail, such that certain vectors occur with such a small frequency that they may be ignored from a practical standpoint. Thus, rating vector distribution analysis module 318 may reduce the number of vectors present in average aspect ratings 316 by keeping only the most frequently occurring vectors, removing vectors having a frequency below a particular threshold frequency (in which case text feature vectors associated with the removed vectors may also be removed), and/or other suitable statistical technique. Rating vector distribution analysis module 318 may generate rating vectors 106 that may be input to training module 108.

As shown in FIG. 3B, a text feature vector creation module 320 may select terms from aggregated review texts for inclusion as part of preliminary text feature vectors 322. In some embodiments, feature text feature vector creation module 320 may select term frequency (tf) as the weight for each term in processed review texts 312. In other embodiments, text feature vector creation module 320 may select term frequency-inverse document frequency weight (tf*idf) as the weight of each term in processed review texts 312. The tf*idf weight for each term is a numerical statistic which reflects how important a term is to a single particular aggregated review text based on the frequency of occurrence of the term in the particular aggregated review text and the frequency of other aggregated review texts including the term. As an example, tf*idf of a term for a particular aggregated review text 314 may be given by tf*idf=tf×idf, where term frequency tf equals the number of times the term appears in the particular aggregated review text 314 and the inverse document frequency idf may be given by idf=log [D/(d∈D:t∈D), where D equals the total number of aggregated review texts 314 and (d∈D:t∈D equals the number of aggregated review texts 314 that the term t appears in (provided that tf for the term t does not equal zero).

Text feature vector creation module 320 may, for each aggregated review text 314, generate a corresponding preliminary text feature vector 322. A preliminary text feature vector 322 corresponding to an aggregated review text 314 may comprise a multiple element vector, wherein each element represents, for each term selected by text feature vector creation module 320, a value indicative of the frequency of occurrence of the term in the corresponding aggregated review text 314. Such values indicative of the frequency of occurrence of the various terms may be given in term frequency (tf), term frequency-inverse document frequency weight (tf*idf), or other suitable indicator of frequency.

As also depicted in FIG. 3B, a refining module 324 may refine the various preliminary text feature vectors 322 based on rating vectors to produce text feature vectors 104. Refining module 324 may, in some embodiments, reduce the dimensionality of text feature vectors. Often, text feature vectors may be characterized by a high dimensionality (often in the range of tens, sometimes hundreds of thousands dimensions), since words are normally used as features and naturally there are thousands of different words in real texts. This very high dimensionality may negatively impact efficiency and effectiveness, thus refining module may reduce the dimensionality of preliminary text feature vectors 322.

Refining module 324 may refine preliminary text feature vectors 322 such that terms occurring in reviews with similar rating vectors 106 are given priority over terms occurring in reviews with less similar rating vectors (e.g., in a three-element rating vector, [5, 5, 5] and [5, 4, 5] would be “more similar” than the vectors [5, 5, 5] and [1, 1, 1]). Accordingly, a relation factor may be applied to adjust the individual vector elements of preliminary text feature vectors 322 to generate text feature vectors 104. As an example, the relation factor R(Ci, Cj) between two rating vectors 106 may be given by R(Ci, Cj)=e^{-α*Distance(Ci, Cj)} where α is a constant, and Distance(Ci, Cj) is the Euclidian distance between multi-dimensional coordinates represented by the various elements of the rating vectors. The value of α may in some embodiments be selected to adjust the relation factor (e.g., in response to evaluation and/or optimization by evaluation/optimization module 114). In some embodiments R(Ci, Cj) may be normalized (e.g., to ensure that Σₖ R(Cₖ, Cj)=1).

In addition refining module 324 may apply the relation factor R(Ci, Cj) to the joint distribution of the class Cj of rating vectors 106 and the term t in preliminary text feature vectors, which may be given by the function P(Cₖ, t). The distribution P(Cₖ, t) may be refined to P_{new}(Cⱼ, t) in accordance with the equation:

P_{new}(Cⱼ,t)=ΣₖP(Cₖ, t)*R(Cₖ, Cj)

P_{new}(Cⱼ, t) may be applied to calculate the information gain score of each term t in preliminary text feature vectors 322 based on information theory. The terms with the highest score values may be retained while others may be discarded.

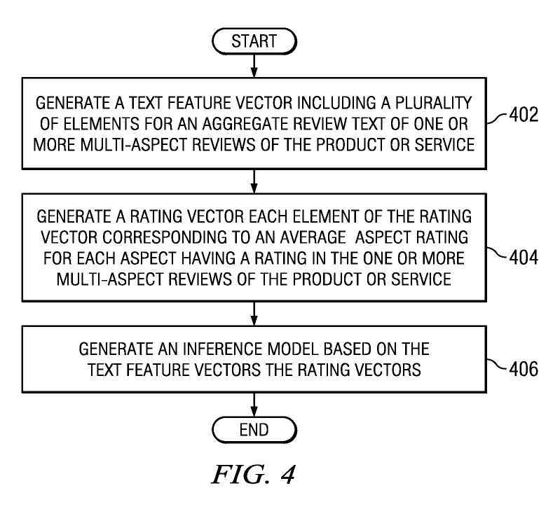

The various components of system 100 may be implemented in hardware, software, or a combination thereof. Components implemented in software may be implemented as a program of instructions embodied in a computer-readable medium (e.g., memory 504 depicted in FIG. 5 described below) and executable by a processor (e.g., processor 502 depicted in FIG. 5 described below).

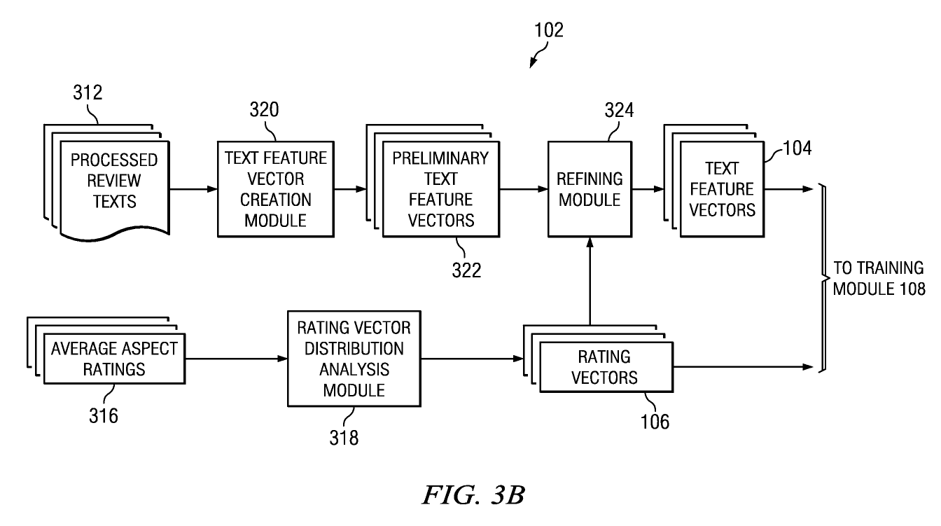

FIG. 4 illustrates a flow chart of an example method 400 of extracting aspect-based ratings from product and service reviews, in accordance with embodiments of the present disclosure. According to one embodiment, method 400 may begin at operation 402. As noted above, teachings of the present disclosure may be implemented in a variety of configurations of system 100. As such, the preferred initialization point for method 400 and the order of the operations 402-406 comprising method 400 may depend on the implementation chosen.

In operation 402, a pre-processing/feature selection module (e.g., pre-processing/feature selection module 102) may generate a text feature vector including a plurality of elements for an aggregate review text (e.g., aggregated review text 306) associated with one or more multi-aspect reviews (e.g., from multi-aspect review sources 120) of a product or service. Each element of the text feature vector may be associated with a term in the aggregate review text, and a value of each element of the text feature vector corresponding to occurrence of a term in the aggregate review text and all aggregate review text collection. In some embodiments, the value of each element of the text feature vector may be a frequency of the term in the aggregate review text. In other embodiments, the value of each element of the text feature vector may be a term frequency-inverse document frequency weight of the term in the aggregate review text, the inverse document frequency weight being based on a total number of aggregated review texts in which the term appears. In these and other embodiments, the pre-processing/feature selection module may analyze an attribute-independent dictionary to extract terms from review texts associated with one or more multi-aspect reviews of the product or service appearing in the attribute-independent dictionary, wherein each element of the text feature vector is associated with a term appearing in an attribute-independent dictionary.

In operation 404, the pre-processing/feature selection module may calculate an average aspect rating (e.g., average multi-aspect rating 316) for each of a plurality of aspects having a rating (e.g., multi-aspect ratings 204) in the one or more multi-aspect reviews of the product or service. The pre-processing/feature selection module may generate a rating vector (e.g., rating vector 106), the rating vector including a plurality of values and elements, each element of the rating vector corresponding to an average aspect rating for each aspect having a rating in the one or more multi-aspect reviews of the product or service. In some embodiments, the rating vector may also be a function of a helpfulness indicator associated with each individual reviews. As an example, the rating vector may given by the equation an R_{avg}=Σ(H*R)/Σ(H), where R_{avg} represents the rating vector, R represents individual rating vectors of individual reviews, and H represents a helpfulness factor vector, each value of the helpfulness factor based on a number of persons viewing a particular review that have indicated that they found the particular review helpful.

In operation 406, a training module (e.g., training module 108) may generate an inference model (e.g., inference model 110) based on the text feature vectors and the rating vectors, such that the inference model may be applied to text reviews (e.g., as embodied by review text vectors 111) to infer aspect ratings (e.g., as embodied by inferred rating vectors 112) associated with the text reviews.

Although FIG. 4 discloses a particular number of operations to be taken with respect to method 400, method 400 may be executed with greater or lesser operations than those depicted in FIG. 4. In addition, although FIG. 4 discloses a certain order of operations to be taken with respect to method 400, the operations comprising method 400 may be completed in any suitable order.

The various operations of system 400 may be implemented in hardware, software, or a combination thereof. Operations implemented in software may be implemented as a program of instructions embodied in a computer-readable medium (e.g., memory 504 depicted in FIG. 5 described below) and executable by a processor (e.g., processor 502 depicted in FIG. 5 described below).

Particular embodiments of the present disclosure may be implemented on one or more computer systems. FIG. 5 illustrates an example computer system 500. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 500 may include one or more computer systems 500; be unitary or distributed; span multiple locations; span multiple machines; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data.

The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate.

Although this disclosure describes and illustrates particular memory, this disclosure contemplates any suitable memory.

In particular embodiments, storage 506 includes mass storage for data or instructions. As an example and not by way of limitation, storage 506 may include an HDD, a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of processor 502 (such as, for example, one or more internal registers or caches), one or more portions of memory 504, one or more portions of storage 506, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA, C, or C++. In particular embodiments, software is expressed in Hyper Text Markup Language (HTML), Extensible Markup Language (XML), or other suitable markup language.

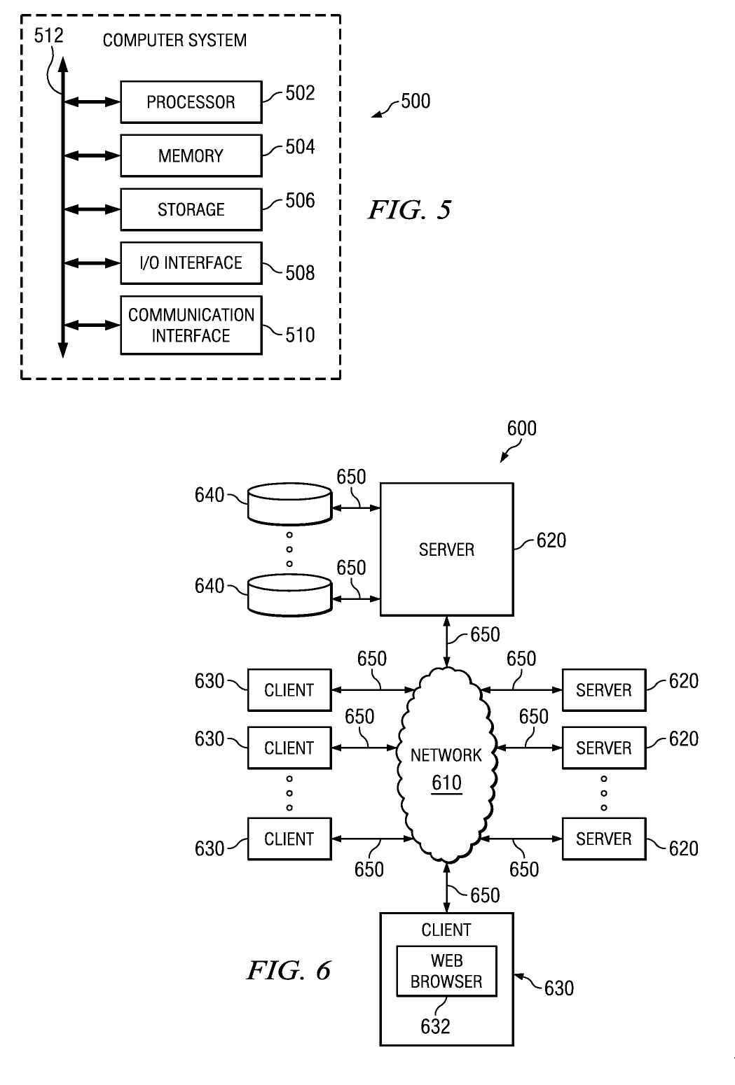

Particular embodiments may be implemented in a network environment. FIG. 6 illustrates an example network environment 600. Network environment 600 includes a network 610 coupling one or more servers 620 and one or more clients 630 to each other. In particular embodiments, network 610 is an intranet, an extranet, a virtual private network (VPN), a local area network (LAN), a wireless LAN (WLAN), a wide area network (WAN), a metropolitan area network (MAN), a portion of the Internet, or another network 610 or a combination of two or more such networks 610. This disclosure contemplates any suitable network 610.

One or more links 650 couple a server 620 or a client 630 to network 610. In particular embodiments, one or more links 650 each includes one or more wireline, wireless, or optical links 650. In particular embodiments, one or more links 650 each includes an intranet, an extranet, a VPN, a LAN, a WLAN, a WAN, a MAN, a portion of the Internet, or another link 650 or a combination of two or more such links 650. This disclosure contemplates any suitable links 650 coupling servers 620 and clients 630 to network 610.

In particular embodiments, each server 620 may be a unitary server or may be a distributed server spanning multiple computers or multiple datacenters. Servers 620 may be of various types, such as, for example and without limitation, web server, news server, mail server, message server, advertising server, file server, application server, exchange server, database server, or proxy server. In particular embodiments, each server 620 may include hardware, software, or embedded logic components or a combination of two or more such components for carrying out the appropriate functionalities implemented or supported by server 620. For example, a web server is generally capable of hosting websites containing web pages or particular elements of web pages. More specifically, a web server may host HTML files or other file types, or may dynamically create or constitute files upon a request, and communicate them to clients 630 in response to HTTP or other requests from clients 630. A mail server is generally capable of providing electronic mail services to various clients 630. A database server is generally capable of providing an interface for managing data stored in one or more data stores.

In particular embodiments, one or more data storages 640 may be communicatively linked to one or more severs 620 via one or more links 650. In particular embodiments, data storages 640 may be used to store various types of information. In particular embodiments, the information stored in data storages 640 may be organized according to specific data structures. In particular embodiments, each data storage 640 may be a relational database. Particular embodiments may provide interfaces that enable servers 620 or clients 630 to manage, e.g., retrieve, modify, add, or delete, the information stored in data storage 640.

In particular embodiments, each client 630 may be an electronic device including hardware, software, or embedded logic components or a combination of two or more such components and capable of carrying out the appropriate functionalities implemented or supported by client 630. For example and without limitation, a client 630 may be a desktop computer system, a notebook computer system, a netbook computer system, a handheld electronic device, or a mobile telephone. This disclosure contemplates any suitable clients 630. A client 630 may enable a network user at client 630 to access network 630. A client 630 may enable its user to communicate with other users at other clients 630.

A client 630 may have a web browser 632, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client 630 may enter a Uniform Resource Locator (URL) or other address directing the web browser 632 to a server 620, and the web browser 632 may generate a Hyper Text Transfer Protocol (HTTP) request and communicate the HTTP request to server 620. Server 620 may accept the HTTP request and communicate to client 630 one or more Hyper Text Markup Language (HTML) files responsive to the HTTP request. Client 630 may render a web page based on the HTML files from server 620 for presentation to the user. This disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could me made hereto without departing from the spirit and scope of the invention.

What is claimed is:

1. A method comprising:
generating a text feature vector including a plurality of elements for an aggregate review text associated with one or more multi-aspect reviews of a product or service, each element of the text feature vector associated with a term in the aggregate review text, and a value of each element of the text feature vector corresponding to a frequency of occurrence of a term in the aggregate review text;
calculating an average aspect rating for each of a plurality of aspects having a rating in the one or more multi-aspect reviews of the product or service;
generating a rating vector, the rating vector including a plurality of values and elements, each element of the rating vector corresponding to an average aspect rating for each aspect having a rating in the one or more multi-aspect reviews of the product or service; and
generating an inference model based on the text feature vectors and a frequency of occurrence of each rating vector, such that the inference model may be applied to text reviews to infer aspect ratings associated with the text reviews.

2. The method of claim 1, the method further comprising analyzing an attribute-independent dictionary to extract terms from review texts associated with one or more multi-aspect reviews of the product or service appearing in the attribute-independent dictionary, wherein each element of the text feature vector is associated with a term appearing in an attribute-independent dictionary.

3. The method of claim 1, wherein the value of each element of the text feature vector is a frequency of the term in the aggregate review text.

4. The method of claim 1, wherein the value of each element of the text feature vector is a term frequency-inverse document frequency weight of the term in the aggregate review text, the inverse document frequency weight being based on a total number of aggregated review texts in which the term appears.

5. The method of claim 1, wherein the rating vector is given by the equation an R_{avg}=Σ(H*R)/Σ(H), where R_{avg} represents the rating vector, R represents individual rating vectors of individual reviews, and H represents a helpfulness factor vector, each value of the helpfulness factor based on a number of persons viewing a particular review that have indicated that they found the particular review helpful.

6. The method of claim 1, each element of the text feature vector selected based on a frequency of occurrence of a term in the aggregate review texts.

7. The method of claim 1, further comprising refining the value of at least one element of at least one text feature vector based on a similarity of rating vectors associated with the term corresponding to the at least one element.

8. The method of claim 7, wherein refining comprises multiplying the at least one element by a relation factor, the relation factor based on a Euclidian distance between multi-dimensional coordinates represented by the elements of the rating vectors associated with the term corresponding to the at least one element.

9. The method of claim 1, further comprising:
applying the inference model to generate inferred rating vectors based on the review texts associated with the one or more multi-aspect reviews of each of the plurality of product or services;
comparing the inferred rating vectors to aspect ratings associated with the one or more multi-aspect reviews of each of the plurality of product or services; and
optimizing generation of the inference model based on the comparison.

10. The method of claim 1, further comprising applying the inference model to generate inferred rating vectors based on text reviews of a product or service.

11. A system comprising:
a memory comprising instructions executable by one or more processors; and
the one or more processors coupled to the memory and operable to execute the instructions, the one or more processors being operable when executing the instructions to:
generate a text feature vector including a plurality of elements for an aggregate review text associated with one or more multi-aspect reviews of a product or service, each element of the text feature vector associated with a term in the aggregate review text, and a value of each element of the text feature vector corresponding to a frequency of occurrence of a term in the aggregate review text;
calculate an average aspect rating for each of a plurality of aspects having a rating in the one or more multi-aspect reviews of the product or service;
generating a rating vector, the rating vector including a plurality of values and elements, each element of the rating vector corresponding to an averaged aspect rating for each aspect having a rating in the one or more multi-aspect reviews of the product or service; and
generate an inference model based on the text feature vectors and a frequency of occurrence of each rating vector, such that the inference model may be applied to text reviews to infer aspect ratings associated with the text reviews.

12. The system of claim 11, the one or more processors being further operable to analyze an attribute-independent dictionary to extract terms from review texts associated with one or more multi-aspect reviews of the product or service appearing in the attribute-independent dictionary, wherein each element of the text feature vector is associated with a term appearing in an attribute-independent dictionary.

13. The system of claim 11, wherein the value of each element of the text feature vector is a term frequency of the term in the aggregate review text.

14. The system of claim 11, wherein the value of each element of the text feature vector is a term frequency-inverse document frequency weight of the term in the aggregate review text, the inverse document frequency weight being based on a total number of aggregated review texts in which the term appears.

15. The system of claim 11, wherein the rating vector is given by the equation an R_{avg}=Σ(H*R)/ Σ(H), where R_{avg} represents the rating vector, R represents individual rating vectors of individual reviews, and H represents a helpfulness factor vector, each value of the helpfulness factor based on a number of persons viewing a particular review that have indicated that they found the particular review helpful.

16. The system of claim 11, the one or more processors being further operable to select each element of the text feature vector based on a frequency of occurrence of a term in the aggregate review texts.

17. The system of claim 11, the one or more processors being further operable to refine the value of at least one element of at least one text feature vector based on a similarity of rating vectors associated with the term corresponding to the at least one element.

18. The system of claim 17, wherein refining comprises multiplying the at least one element by a relation factor, the relation factor based on a Euclidian distance between multi-dimensional coordinates represented by the elements of the rating vectors associated with the term corresponding to the at least one element.

19. The system of claim 11, the one or more processors being further operable to:
apply the inference model to generate inferred rating vectors based on the review texts associated with the one or more multi-aspect reviews of each of the plurality of product or services;
compare the inferred rating vectors to aspect ratings associated with the one or more multi-aspect reviews of each of the plurality of product or services; and
optimize generation of the inference model based on the comparison.

20. The system of claim 11, the one or more processors being further operable to apply the inference model to generate inferred rating vectors based on text reviews of a product or service.

21. One or more computer-readable non-transitory storage media embodying software operable when executed by one or more computer systems to:
generate a text feature vector including a plurality of elements for an aggregate review text associated with one or more multi-aspect reviews of a product or service, each element of the text feature vector associated with a term in the aggregate review text, and a value of each element of the text feature vector corresponding to a frequency of occurrence of a term in the aggregate review text;
calculate an average aspect rating for each of a plurality of aspects having a rating in the one or more multi-aspect reviews of the product or service;
generating a rating vector, the rating vector including a plurality of values and elements, each element of the rating vector corresponding to an averaged aspect rating for each aspect having a rating in the one or more multi-aspect reviews of the product or service; and
generate an inference model based on the text feature vectors and a frequency of occurrence of each rating vector, such that the inference model may be applied to text reviews to infer aspect ratings associated with the text reviews.
